(19) United States
(12) Patent Application Publication
(10) Pub. No.: US 2001/0002297 A1
(43) Pub. Date: May 31, 2001

(54) Pyrotechnic layer for the targeted destruction of data on data carriers

(76) Inventors: Philemon Schweizer, Atritz (AT); Carl Hug, Oberdiessbach (CH); Georgios Karametaxas, Bern (CH); Jorg Kutzli, Hofen (CH); Markus Tobler, Seftigen (CH)

Correspondence Address: JAY A. BONDELL, ESQ., SCHWEITZER CORNMAN GROSS & BONDELL LLP, 19th FLOOR, 292 MADISON AVENUE, NEW YORK, NY, 10017, US

(21) Appl. No.: 09/747,206

(22) Filed: Dec. 22, 2000

Related U.S. Application Data
(63) Continuation of application No. PCT/CH99/00276, filed on Jun. 28, 1999.

(30) Foreign Application Priority Data
Jun. 29, 1998 (EP) EP 98810602.7
Jun. 7, 1999 (CH) CH 1065/99

(51) Int. Cl. B32B 15/04; C06B 27/00; C06B 33/00

(52) U.S. Cl. 428/702; 428/613; 427/419.2; 428/469; 149/108.2; 149/5

(57) ABSTRACT

A data carrier, such as a memory disk, is provided with a pyrotechnic layer which can be ignited to destroy the data on the carrier. The pyrotechnic layer has an inert lining and can be triggered by a conventional electrical ignitor. The layer is based on a thermite mixture having an excess reducing agent.

### BACKGROUND OF THE INVENTION

The high storage density of current data carriers entails a considerable risk of data misuse in the private, economic and military domains. Therefore, the task has arisen of completely destroying data before it falls into the hands of unauthorized individuals. Owing to the worldwide dissemination of compact disks (CD-ROM or CD read-only memory) and the increasing dissemination of digital versatile disks (DVDs), this task has become a technical challenge, especially since the objective of the creators of that generation of data carriers was to ensure the inviolability of the stored data.

Various attempts at destroying CD-ROMs and DVDs quickly and safely have failed, in particular because data structures which have not been completely destroyed can be made legible again by current means of reconstructing data using optical devices and algorithms originating from data encryption technology. The highest data destruction rate with the least technical expenditure has been achieved in the laboratory by thermally destroying the data by means of thin pyrotechnic layers in the form of films. However, their physical association with the data carriers gave rise to unexpected difficulties, in particular with respect to their adhesiveness, layer thickness, reaction rate on combustion and their irregular and often non-reproducible combustion behavior.

GE-A-2 282 136 discloses inter alia a pyrotechnic film in which a quickly oxidizing material is applied to both sides of a structured layer acting as an oxidant. Following ignition, the two layers bring about a strongly exothermic process with a high reaction rate and generate a combustion temperature of several thousand degrees Celsius.

Practical experiments have shown that a film of this type, which was developed for the ignition of gas generators and rocket engines, burns away too quickly and too greatly affects or even destroys the environment of the data carriers. For safety reasons alone, its use with CD-ROMs, DVDs and CD-RWs (CD rewriter drives) is out of the question.

Therefore, the object of the present invention is to produce a pyrotechnic layer for the destruction of data on carriers, in particular read-only memory disks, which does not have the aforementioned disadvantages, ensures complete destruction of all data and requires a layer thickness of less than 1.0 mm. The layer must adhere mechanically and properly to conventional carriers and must also resist any thermal expansion and/or flexion and must not flake off in practical use. Furthermore, the pyrotechnic layer must not include any toxic substances and/or produce them either alone, or in combination or reaction with housing parts or data carriers themselves.

### BRIEF DESCRIPTION OF THE INVENTION

In accordance with the foregoing and other objects and purposes, a pyrotechnic layer of the present invention is arranged on or in a flat substrate in the operating region of the data carrier, and comprises a pyrotechnic material incorporated into an inert substrate. The substrate may be an inert metal, the pyrotechnic material being introduced into a series or network of pores therein. Alternatively, the inert material may take the form of a non-metallic, non-woven fabric or other structure, such as a mesh, burled, or honeycomb structure, capable of receiving the pyrotechnic material. The pyrotechnic material may comprise a thermite mixture.

The term “inert material” or “inert metal” used herein are taken to mean that the material makes no or only a relatively small contribution to the temperature increase during the combustion of the pyrotechnic layer and is therefore not primarily reactive, in contrast to the structured material according to GB-A-2 282 136. Such inert materials may include both metal and non-metal substrate materials.

High mechanical strength is obtained by means of the inert carrier structure. In addition, a targeted evolution and propagation of heat is achieved, in which the inert structure forms a type of thermal buffer and prevents uncontrolled energy losses caused by diffusion.

The overall energy can be kept low by the structure of the invention. There is no risk of fire, and the devices to be used suffer no or little damage due to the resulting evolution of heat. System users are also not endangered by explosions, or the like.

The present invention can be used universally in connection with driver/reader devices and on data storage devices owing to its good adhesiveness and the small layer thickness required.

The incorporation of a range of inert material structures opens up a wide range of applications. Both the formation of very thin layers and improved adhesion, in particular to the polycarbonate of CD-ROMs, etc., and reduced sensitivity to vibration and shock can be achieved by differing constructions of the invention.

Use of a glass-fiber non-woven fabric is particularly suitable. It is commercially available as a finished product and has great flexibility. Non-woven fabrics comprising other materials such as fine rock wool or textiles, which can produce no or only a little reaction heat, can also be used. Relatively thin non-woven fabrics are sufficient, an optimum weight per unit area being in the region of 30 g/m².

Thermite mixtures have proved successful and are advantageously not stoichiometric mixtures, as these react very vigorously. The inclusion of excess reducing agent can allow the reaction rate to be controlled. The inclusion of powdered iron may permit an optimum temperature gradient in the storage medium. The iron does not primarily participate in the main chemical reaction; it reduces the reaction temperature and releases the absorbed energy in the form of radiation in a time-delayed manner.

Use of an inert metal substrate in the form of an open pore foam as the inert carrier structure forms a three-dimensional lattice having excellent mechanical and adhesive properties. Such a metal substrate, like the non-woven fabric, mesh, burled and/or honeycomb structure, does not participate in the chemical reaction; it acts primarily as an energy store.

Surprisingly, a pyrotechnic mass introduced into the metal substrate adheres outstandingly well in the latter without any further surface treatments, etc. The metal substrate can also be glued without any problems to other materials, without the disadvantages which may exist with adhesion of the pyrotechnic mass.

A nickel or nickel alloy metal foam is commercially available with a porosity of 90% to 95%, making it capable of absorbing a large pyrotechnic mass. Such a metal foam has proved particularly successful because it is also chemically inert at the high temperatures produced during combustion and therefore no exothermic heat is generated.

A pyrotechnic layer in the range of 0.3 to 0.6 mm has been found to be a preferable thickness and, in the case of rotating data carriers, cause only controllable imbalances which can easily be compensated for by known means. The pyrotechnic layer may be exposed or covered by a protective layer or the like. A polymeric protective layer can be applied in the form of a protective lacquer. Protection against mechanical damage and/or untimely initiation can also be provided by other covering materials, such as metal foils or plastic films.

An incandescent igniter with connecting channels containing an igniting composition may be utilized to form an ignition chain to facilitate the targeted and rapid destruction of stored data and the data carrier itself in emergency situations. An integral power supply incorporating a miniature battery can increase system safety and facilitate the automated triggering of data destruction.

The pyrotechnic layer of the present invention may be formed by compounding the components of the pyrotechnic mass with an appropriate binder and subsequently adding an appropriate spreading agent, such as butyl acetate, to form a spreadable mass. The mass is then applied to the inert substrate and dried.

Although there is a wide variety of possible methods of applying the pyrotechnic mass, the screen printing process commonly known from printing technology is particularly advantageous because it permits precise positioning of the mass and thus produces little waste. It is also well suited to discontinuous batch operation during preparation of the mass.

The pyrotechnic layer of the invention may be applied in a simple manner either to the upper surface of a CD-ROM, to its caddy or as an intermediate layer in the case of a DVD readable on both sides. The pyrotechnic layer can be incorporated into the operating region of data carriers such as CD-ROM and DVD servers, jukeboxes, CD rewriters, MO, ZIP, JAZ, PC-card and PD drives. The layer can be incorporated in the same way into any other removable data carriers without difficulty.

The arrangement of one or more pyrotechnic layers in a multi-layer data carrier is also possible, but may require additional working steps, known to those skilled in the art, in the manufacturing process and adjustment and/or adaptation of the optical reading system to the modified layer thicknesses and the position of the data planes.

The pyrotechnic layer can also be directly incorporated into component parts of readers, these parts preferably being of a replaceable nature.

### BRIEF DESCRIPTION OF THE DRAWINGS

Embodiments of the invention will be described in the following with reference to the annexed drawings, wherein:

FIG. 1 is a section view through a CD-ROM having an upper pyrotechnic layer in accordance with the invention;

FIGS. 2a-2c are enlarged cross-sectional views of three variants of the pyrotechnic layer;

FIG. 2d is an enlarged sectional view of a metallic foam which may be used for the inert structure of the invention;

FIG. 2e is an enlarged sectional view of a pyrotechnic layer utilizing the metallic foam of FIG. 2d;

FIG. 3 is a partial sectional view of a DVD with an intermediate pyrotechnic layer;

FIG. 4 is a partial section view of the DVD taken along line x-x of FIG. 3 depicting the intermediate layer with its aids for the parallel arrangement of the data carriers;

FIG. 5 is a top plan view of a caddy with a pyrotechnic layer having an integral voltage source and ignition device; and

FIG. 6 is a sectional view of a data cartridge illustrating the basic principle of the association of pyrotechnic layers with data carriers.

In all the figures, like functional parts are provided with like reference numerals.

### DETAILED DESCRIPTION OF THE INVENTION

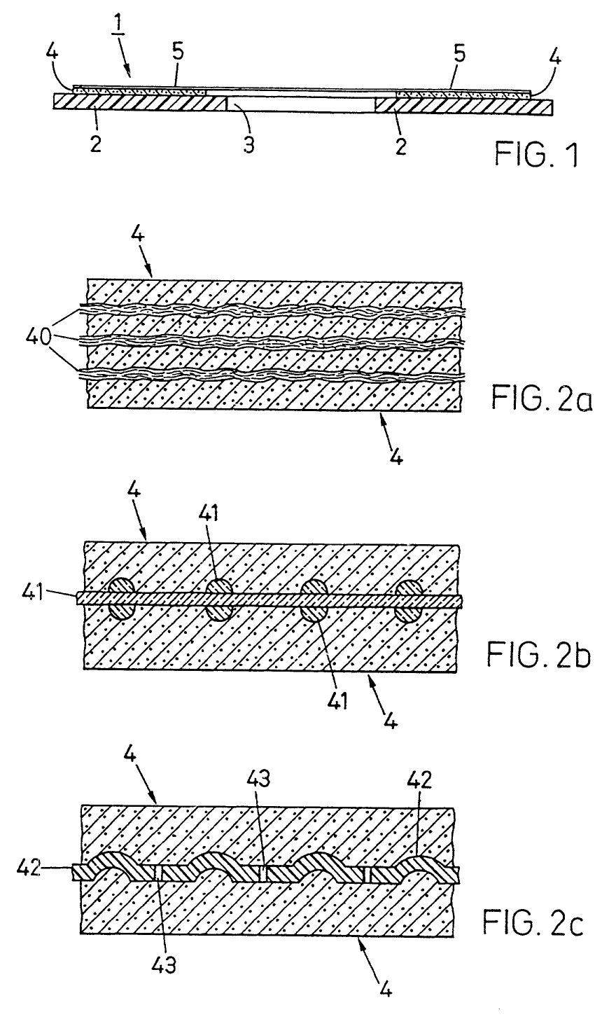

A pre-recorded/written CD-ROM is designated by 1 in FIG. 1. A pyrotechnic layer 4 is glued onto the data carrier portion 2 of this commonly known, commercially available CD-ROM 1 and extends radially inwardly as far as the inner (first) data track, terminating 5 mm from the bore 3 and, correspondingly, extending outwardly as far as the last data track, terminating 5 mm from the periphery of the disk. A conventional imprint 5 may be provided thereabove, either in the form of a printed label or applied by screen printing.

The CD-ROM thus coated can be initiated by known ignition means and, owing to the considerable resulting evolution of heat, loses all the data, i.e. all the bits become illegible without the polycarbonate of the data carrier igniting.

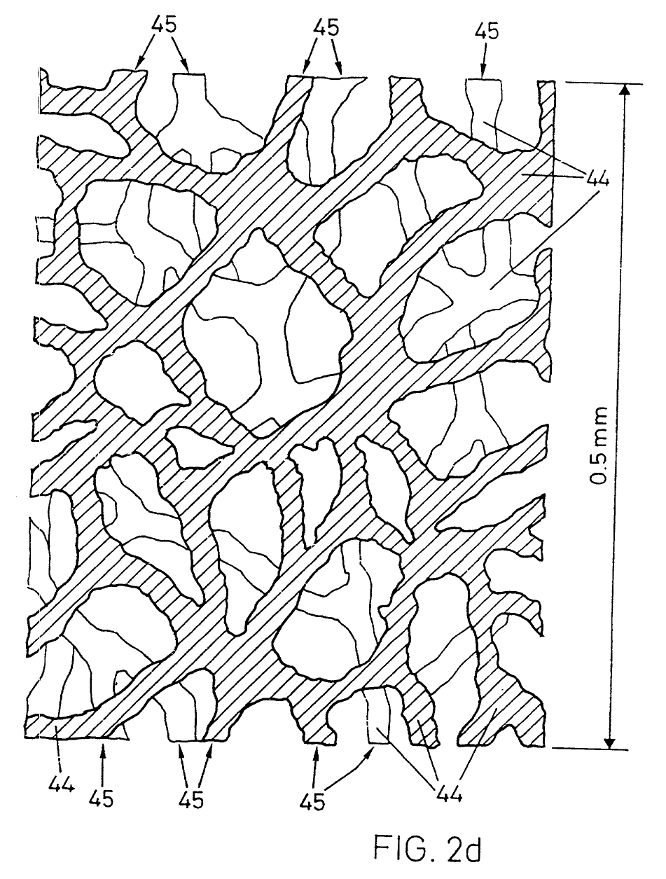

FIGS. 2a to 2c show simplified sectional views of variants of the pyrotechnic layer 4 according to the invention. In all cases, the layer thickness is 0.4 mm. They differ only in the type of inert substrate structure utilized. In FIG. 2a, the inert substrate structure is a triple-layered non-woven fabric 40 comprising glass fibers; in FIG. 2b, it is a tissue/mesh 41, likewise comprising glass fibers, and in FIG. 2c, it is a film 42 having a burled structure and regularly distributed holes 43 and comprising a mineral or metal material. Heat-resistant plastics can also be used.

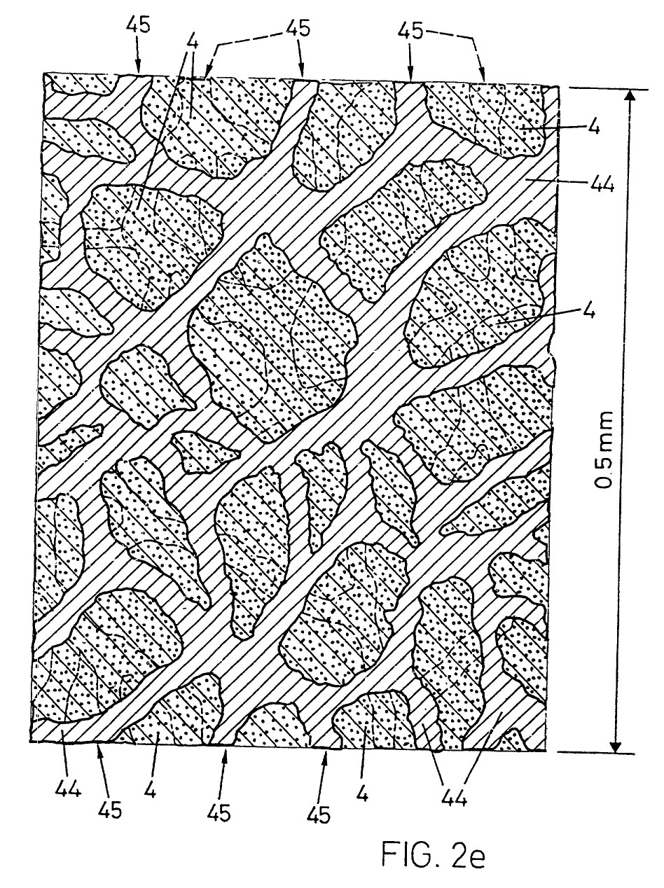

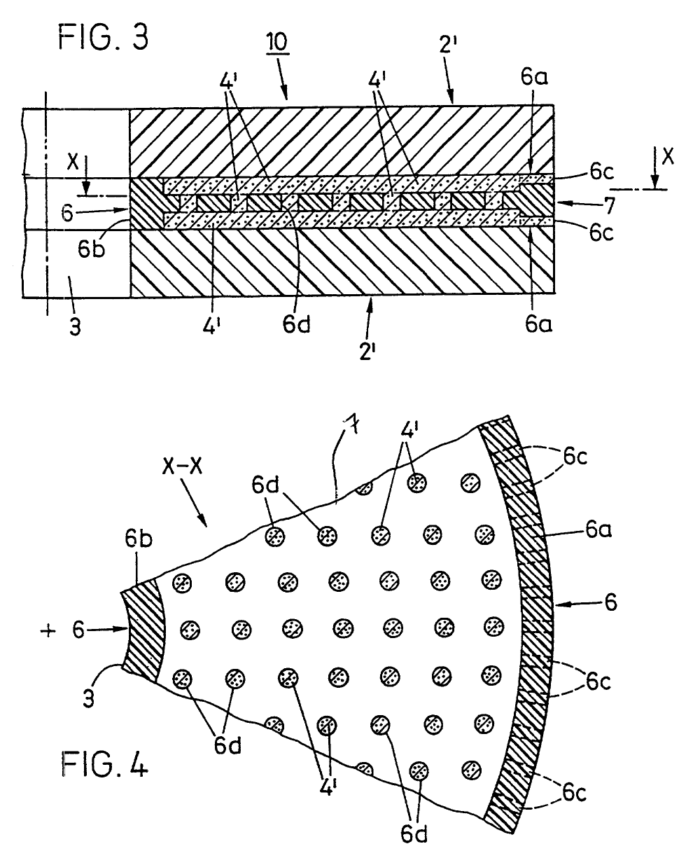

FIGS. 3 and 4 depict a portion of a DVD 10 with a centrally arranged, compact pyrotechnic layer 4′. While the two data carriers 2′ are constructed and recorded in a conventional manner, the layer 4′ comprises an intermediate layer 6 formed as a spacer between them.

The intermediate layer 6 is formed with a substrate in the form of an interior toroidal core 7 having an outer, thickened ring portion having radial openings 6c through which the pyrotechnic mass extends outwardly. A flat, disc-like central portion of the substrate core is provided with numerous holes 6D through which the pyrotechnic mass extends and joins upper and lower portions thereof applied to the corresponding surfaces of the substrate. An inner ring portion 6b of the substrate core forms an inner support for the intermediate layer 6 and a side wall for the pyrotechnic mass.

The pyrotechnic layer 4′ is in itself equivalent to that shown in FIG. 2a, except that its pyrotechnic mass is further connected to the upper and lower surfaces of the substrate by means of the honeycomb structure formed by the holes 6d in the substrate. Because the pyrotechnic mass extends outwardly through the radial holes 6c, the DVD 10 can be ignited from the outside, which ignition can even be carried out during operation by the means described hereinbelow.

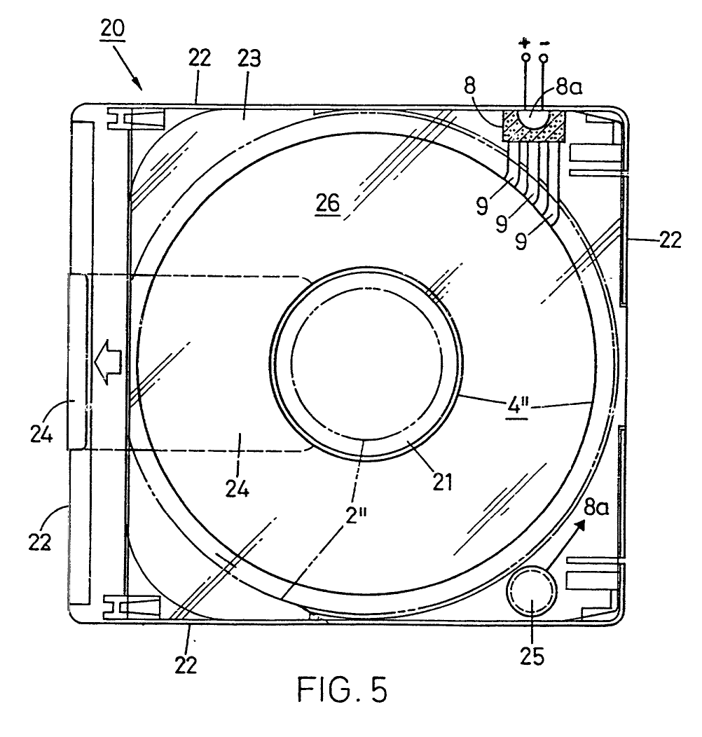

FIG. 5 shows the incorporation of a pyrotechnic layer 4″ into a conventional caddy 20. The two side walls are designated here by 23, the four ends by 22 and the reading slide by 24. The pyrotechnic layer 4″ is applied upon the inner surface of the transparent cover 26 of the caddy 20 and arranged concentrically about the portion 21 of the cover overlying the bearing flange of the CD-ROM. The boundary lines of the layer 4″ can be seen in FIG. 5. A concentric recess is advantageously provided for the pyrotechnic layer on the inner surface of the cover 26, the pyrotechnic layer being let into the recess and forming a plane with the inner surface of the cover.

FIG. 5 also shows an ignition element 8 comprising an incandescent igniter 8a and three ignition channels 9 which ignite the layer 4″ by means of electrical initiation. The ignition channels lie on the inner surface of the cover 26.

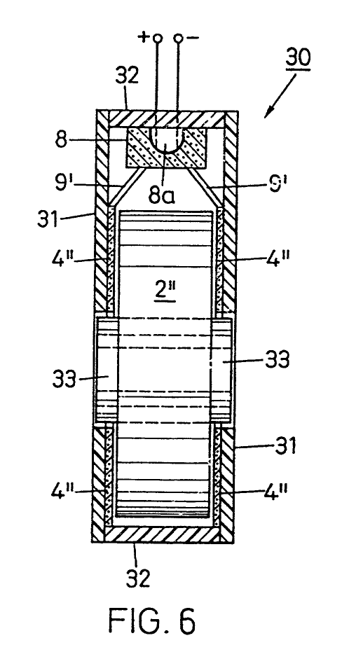

The incandescent igniter 8a can be initiated via its connections characterized by + and − by a control command of a connected computer and via its own power source 25. However, the independent power source 25—one or more button cells connected in series— also permits different, for example, electromechanical triggering of the igniter. Instead of direct ignition of the incandescent igniter 8a by means of the power source 25, an induction coil could also be used to supply a pulsed current to the incandescent wire of the igniter.

Whereas the hitherto described embodiments relate to flat data carriers, namely disks, FIG. 6 relates to a tape-type carrier, namely DLT (digital linear tape) or DAT (digital audio tape), but can also be incorporated into any floppy disk drive in a similar manner and is thus not restricted to a particular data carrier.

In accordance with the sectional view shown in FIG. 6, the corresponding cartridge 30 is constructed in the usual manner. It has two opposing side walls 31 spaced apart by end walls 32, and its data carrier media 2″ mounted therebetween is wound upon spools 33. The pyrotechnic layer 4″ is applied to the inner surfaces of the side walls 31, while the igniter element 8 may be affixed to an end wall 32.

For spatial reasons, the pyrotechnic layer 4″ is very thin, only 0.25 mm thick. However, the thermal energy is easily sufficient to destroy the data on ignition because it acts on the data carrier 2″ from both sides.

The two layers 4″ are synchronously ignited via two symmetrical ignition channels 9′ connected to the ignition element 8 itself provided with an incandescent igniter 8a.

A method of producing the pyrotechnic layer of the invention is carried out using conventional techniques: In a first method step, 30% by weight of Fe₂O₃, 16% by weight of MnO₂, 13% by weight of Al, 21% by weight of Zr and 20% by weight of Fe are mixed together and 3% by weight of polymeric binders are then added to this mixture. In a second method step, butyl acetate is added until a spreadable mass is formed which, in a third method step, is applied to a mesh,burled, and/or honeycomb structure of inert material, spread smooth and dried.

A preferred embodiment of the method of producing a pyrotechnic layer with a thickness of 0.4 mm is as follows:

In a first method step, 30% by weight of Fe₂O₃, 16% by weight of MnO₂, 13% by weight of Al, 21% by weight of Zr and 20% by weight of Fe are mixed together as dry substances in a mortar and 12% by weight of binder 14 comprising styrene copolymer and modified rosin is then additionally added to this mixture. In a second method step, 52% by weight of butyl acetate is added to produce a spreadable mass and, in a third step, this mass is applied to a non-woven fabric comprising glass fibers by means of a conventional spreader. The spreader is slowly moved over the non-woven fabric at a constant rate to ensure that the latter is completely saturated with the pyrotechnic mass. The layer thus formed is then dried at 70°C. for 3 h.

The components of the pyrotechnic mixture have the following average particle sizes:

zirconium<5 μm

aluminum<100 μm

iron dioxide<100 μm

manganese oxide<100 μm

iron<150 μm

The binder 14 used is commercially available (Proga AG, CH-2540 Grenchen). The spreader is of the Erichson type (DESAG GmbH KG, D-58675 Hemer). The non-woven fabric is a “two-dimensional” non-woven fabric with a weight per unit area of 27 g/m² (ASEOL no. 31-56 made by ASEOL AG, CH-3000 Bern). The weight data for the binder and the butyl acetate are based on the total mass of the dry substance of the mixture.

The pyrotechnic layer is gluable to most surfaces, in particular when the surfaces have been roughened, using commercially available spray adhesives (e.g. Miranit manufactured by Ed. Geistlich und Sohne AG, CH-8952 Schlieren).

It is additionally recommended to spray the glued layer with a thin coating of clear lacquer, for example zapon lacquer, in order to increase its abrasion resistance.

In all cases, it has been demonstrated by practical testing that safe ignition of the pyrotechnic layer is also ensured during operation, i.e. during the read-out of data, and that even then no reconstructible data structures remain after ignition.

A preferred embodiment of the invention utilizing an inert metal substrate is shown in further detail in FIGS. 2d and 2e.

FIG. 2d shows a section through a nickel foam after having been rolled to a desired layer thickness of 0.5 mm. Its sponge-like structure is designated by 44 with side edge surfaces 45. The metal foam is commercially available as a flat material in the form of strips with a thickness of 1.5 mm (International Nickel GmbH, D-40211 Dusseldorf). It is brought to the desired thickness in the present case 0.5 mm, by calendaring (rolling) and then being cut to the desired external form.

The pyrotechnic mass is produced in the same way as for the glass-fibre non-woven fabric, although in this case the higher thermal capacity of the metal foam in relation to a glass-fibre non-woven fabric is taken into account, as follows:

In a first step, 34.4% by weight of Fe₂O₃, 18.6% by weight of MnO₂, 14.9% by weight of Al and 25.1% by weight of Zr are mixed together and 7% by weight of polymeric binders are then added to this mixture. In a second step, butyl acetate is added until a spreadable mass is formed.

This mass is then introduced into the metal foam of FIG. 2d by a known screen printing process and dried; see FIG. 2e which shows an enlarged plan view of one end of the pyrotechnic layer ready for use.

It can also be seen from FIG. 2e that the edge surfaces 45 of the actual structure 44 of the metal foam form a junction and thus the defined adhesion surface with the base (CD-ROM, DVD or caddy) to which the pyrotechnic layer is applied. A conventional contact adhesive which is sprayed on has again proved successful to adhere the pyrotechnic layer to the base surface.

If this pyrotechnic layer is used in connection with DVDs of high storage capacity (>8.5 Gbyte), it is recommended that the layer be placed between the levels (written reflectors), which produces an increase in the thickness of the DVD of at most 0.5 mm with an otherwise identical structure.

Owing to the flat surface of the pyrotechnic layer of the invention and the possibility of being able to introduce the pyrotechnic mass by screen printing precisely at a thickness of only tenths of a millimeter into the metal foam, also provided with flow holes, as exemplified in FIGS. 3 and 4, a sandwich-type structure as depicted therein, can also be precisely produced without causing relatively great imbalances in the rotating disk. Naturally, the focussing of the reader and/or recorder must be adapted to the positions of the data levels which may differ from standard.

A pyrotechnic layer of the sandwich type may be initiated via an ignition chain with a conventional incandescent igniter (electric primer capsule T7 manufactured by Comet GmbH, D-27574 Bremerhaven). The igniter acts on a combustible composition which is introduced into channels and is directed towards the exposed ends of the pyrotechnic layer.

The combustible composition is known per se and may comprise 66% zirconium FA and 34% manganese dioxide.

In order to ensure safe ignition in DVDs and the like having a high rotational speed, the size and positioning of channels for the combustible composition must be kept very small and precise to avoid deflection of the ignition stream to outer boundary layers.

The pyrotechnic layer described hereinabove can be incorporated into numerous other data carriers and similar structures and can easily be adapted to the specific requirements of the desired data destruction. Depending on the field of application and the quantity, other methods of introducing the pyrotechnic mass into the metal foam are also possible, for example coatings on a turntable, vacuum filling processes, etc.

The subject of the invention is not limited to electro-optical data storage systems. It can be applied just as well to magnetic, magneto-optical and also electronic storage. The small layer thickness required and the optimum distribution of heat within the ignited layer allow successful integration into most removable disk systems, irrespective of whether they function on an electronic, magnetic, magneto-optical or purely optical basis and without substantial structural changes being necessary.

The invention can also easily be combined with external and internal electromechanical and/or electronic and/or software security measures, for example so that any unauthorized attempt to access the stored data and/or the unauthorized removal of the data carrier initiates its destruction.

We claim:

1. A pyrotechnic layer for the targeted destruction of machine-readable data on a data carrier, the pyrotechnic layer being located on or in a flat substrate located in the region of a data-bearing portion of the data carrier, comprising a pyrotechnic material associated with an inert material substrate carrier.

2. The pyrotechnic layer of claim 1 wherein the inert material substrate carrier comprises at least one of a non-woven fabric, mesh, burled or honeycomb structure.

3. The pyrotechnic layer of claim 1 wherein the inert material substrate carrier has a pore structure with side surfaces and is formed from an inert metal, the pyrotechnic material being introduced into the pore structure, the side surfaces being adhesion surfaces for the pyrotechnic layer.

4. A pyrotechnic layer according to claim 2, wherein the inert material substrate is a glass fiber or rock wool non-woven fabric.

5. A pyrotechnic layer according to claim 4, characterized in that the non-woven fabric has a weight per unit area of less than 50 g/m².

6. A pyrotechnic layer according to claim 2, wherein the pyrotechnic material comprises a thermite mixture.

7. A pyrotechnic layer according to claim 6, wherein the thermite mixture includes an excess of a reducing agent in relation to the stoichiometric ratio of the thermite mixture.

8. A pyrotechnic layer according to claim 7, characterized in that the thermite mixture includes a heat accumulator in powder form up to 30% by weight of iron, nickel, tungsten or copper.

9. A pyrotechnic layer according to claim 8, characterized in that the thermite mixture comprises 30% by weight Fe₂O₃, 16% by weight MnO₂, 13% by weight Al, 21% by weight Zr and 20% by weight Fe.

10. A pyrotechnic layer according to claim 3, characterized in that the metal substrate is an open-pore metal foam.

11. A pyrotechnic layer according to claim 10, characterized in that the metal foam comprises nickel or a nickel alloy.

12. A pyrotechnic layer according to claim 1, 2 or 3, having a thickness of 0.3 mm to 0.6 mm.

13. A pyrotechnic layer according to claim 1, 2 or 3, further comprising an outer protective layer of metal, ceramic or polymer.

14. A pyrotechnic layer according to claims 1, 2 or 3, further including an incandescent igniter and connected channels containing an igniting composition.

15. A pyrotechnic layer according to claim 14, further including an independent power supply associated with the incandescent igniter.

16. A method of producing a pyrotechnic layer according to claim 2 characterized in that, in a first step 30% by weight Fe₂O₃, 16% by weight MnO₂, 13% by weight Al, 21% by weight of Zr and 20% by weight of Fe are mixed together and 3% by weight of polymeric binders are then added to the mixture; in a second step butyl acetate is added until a spreadable mass is formed; and in a third step, the spreadable mass is applied to the substrate, spread smooth and dried.

17. A method of producing a pyrotechnic layer according to claim 2, characterized in that, in a first step 30% by weight Fe₂O₃, 16% by weight MnO₂, 13% by weight Al, 21% by weight Zr and 20% by weight of Fe are mixed together and 12% by weight of polymeric binders are then added to the mixture; in a second step 52% by weight butyl acetate is added until a spreadable mass is formed; and in a third step the mass is applied to the substrate, spread smooth and dried.

18. A method of producing a pyrotechnic layer according to claim 3, characterized in that, in a first step 34.4% by weight Fe₂O₃, 18.6% by weight MnO₂, 14.9% by weight Al and 25.1% by weight Zr are mixed together and 7% by weight polymeric binders are then added to the mixture; in a second step butyl acetate is added until a spreadable mass is formed; and, in a third step the mass is introduced into the pores of the metal substrate and then the mass is spread smooth, dried and then glued on.

19. A method according to claim 18, characterized in that, in a preliminary step, a prefabricated metal substrate is rolled to a desired layer thickness, and in the third step the spreadable mass is introduced into the metal substrate by screen printing.

20. A method according to any one of claims 16 to 18, characterized in that the produced pyrotechnic layer is located in the data-bearing portion region of the data carrier by means of a spray adhesive.

21. The pyrotechnic layer of claim 1, 2, or 3, wherein the flat substrate comprises a portion of a data carrier caddy or a removable data carrier.

22. The pyrotechnic layer of claim 1, 2 or 3, wherein the flat substrate comprises a portion of a surface of a compact disk.

23. The pyrotechnic layer of claim 1, 2 or 3, wherein the pyrotechnic layer is an intermediate layer of a digital versatile disk.

24. The pyrotechnic layer of claim 1, 2 or 3, wherein the flat substrate comprises a portion of a housing of a reader for a data carrier.
